(19) United States
(12) Patent Application Publication
(10) Pub. No.: US 2014/0103023 A1
(43) Pub. Date: Apr. 17, 2014

(54) Household Electro-Thermal Vaporization Converter

(71) Applicant: Yao-Tsung Kao, Tainan City (TW)

(72) Inventor: Yao-Tsung Kao, Tainan City (TW)

(21) Appl. No.: 13/650,171

(22) Filed: Oct. 12, 2012

(51) Int. Cl. F22B 1/28; H05B 1/02; A47J 27/04

(52) U.S. Cl. CPC F22B 1/282; A47J 27/04; H05B 1/0269
USPC 219/401; 392/397; 219/481; 126/369

(57) ABSTRACT

A converter includes a heating bar, a water line, and a covering layer. Either the water line or the covering layer is mounted on the heating bar. The covering layer has a helical channel wound around the heating bar. Each of the water line and the helical channel is connected with a water tank and at least one nozzle. When the heating bar is conducted by the power supply, either the water line or the helical channel is heated, with air in either the water line or the helical channel being expanded to suck a liquid in the water tank into either the water line or the helical channel by a siphon principle, and with the liquid being heated successively to produce a high temperature steam which is sprayed outward through the nozzle to cook foods.

### BACKGROUND OF THE INVENTION

1. Field of the Invention

The present invention relates to a converter or heater and, more particularly, to a household electro-thermal vaporization converter for an electric or electronic appliance, such as a pot, kettle, oven and the like.

2. Description of the Related Art

A conventional electric (or electronic) pot comprises a pot body, an inner pan received in the pot body, and a lid removably mounted on the pot body to close the inner pan. When foods and liquid are placed into the inner pan, the lid covers the pot body. Then, the bottom of the pot body is heated to increase the temperature in the pot body and the inner pan so as to boil the liquid and cook the foods. However, the temperature in the pot body and the inner pan is increased gradually so that the foods are cooked slowly, and the liquid is boiled slowly. In addition, the pot body is kept at a warming state after the cooking process is finished so that the foods in the inner pan will not be heated successively and will be easily dried or hardened.

### BRIEF SUMMARY OF THE INVENTION

In accordance with one embodiment of the present invention, there is provided a converter, comprising a heating bar, a water line, and a covering layer. The heating bar is connected with a power supply. The water line is hollow. Either the water line or the covering layer is mounted on the heating bar. The water line is selectively wound around the heating bar. The covering layer has an interior formed with a helical channel selectively wound around the heating bar. Each of the water line and the helical channel of the covering layer has a first end connected with a water tank and a second end connected with at least one nozzle. When the heating bar is conducted and heated by the power supply, either the water line or the helical channel of the covering layer is heated to increase its temperature successively, with air in either the water line or the helical channel of the covering layer being expanded to suck a liquid in the water tank into either the water line or the helical channel of the covering layer by a siphon principle, and with the liquid being heated successively in either the water line or the helical channel of the covering layer to produce a high temperature nanometer steam. The high temperature nanometer steam is sprayed outward through the nozzle. The heating bar is bent to have any shape. The converter includes more than one nozzle. The converter further comprises a heat insulating layer mounted on an outer surface of the heating bar, the water line or the covering layer.

In accordance with another embodiment of the present invention, there is provided a converter, comprising a heating bar and a water line or a covering layer, wherein the converter is placed in any position of a closed chamber or a lid. The closed chamber is a pot, kettle or oven. The closed chamber is provided with a waterless power interruption device and a safety device each connected with a power supply of the heating bar.

According to the primary advantage of the present invention, the liquid water is vaporized instantaneously by operation of the converter to produce a high temperature steam which is used to cook the foods quickly and completely, so as to keep the freshness of the foods, and to shorten the cooking time.

According to another advantage of the present invention, the converter is available for various electric (or electronic) appliances, such as pots, pans, ovens, kettles and the like, thereby enhancing the versatility of the converter.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a flow chart of a converter in accordance with the preferred embodiment of the present invention.

FIG. 2 is a front view of the converter in accordance with the preferred embodiment of the present invention.

FIG. 3 is a front view of a converter in accordance with another preferred embodiment of the present invention.

FIG. 4 is a perspective view of a converter in accordance with another preferred embodiment of the present invention.

FIG. 5 is a front cross-sectional view of the converter as shown in FIG. 4.

FIG. 6 is a perspective view of the converter for an electric (or electronic) pot in accordance with the preferred embodiment of the present invention.

FIG. 7 is a front cross-sectional view of the converter for an electric (or electronic) pot as shown in FIG. 6.

FIG. 8 is a front cross-sectional view of the converter for a stock pot in accordance with another preferred embodiment of the present invention.

FIG. 9 is a front cross-sectional view of the converter for a kettle in accordance with another preferred embodiment of the present invention.

FIG. 10 is a front cross-sectional view of the converter for an oven in accordance with another preferred embodiment of the present invention.

FIG. 11 is a front cross-sectional view of a converter in accordance with another preferred embodiment of the present invention.

### DETAILED DESCRIPTION OF THE INVENTION

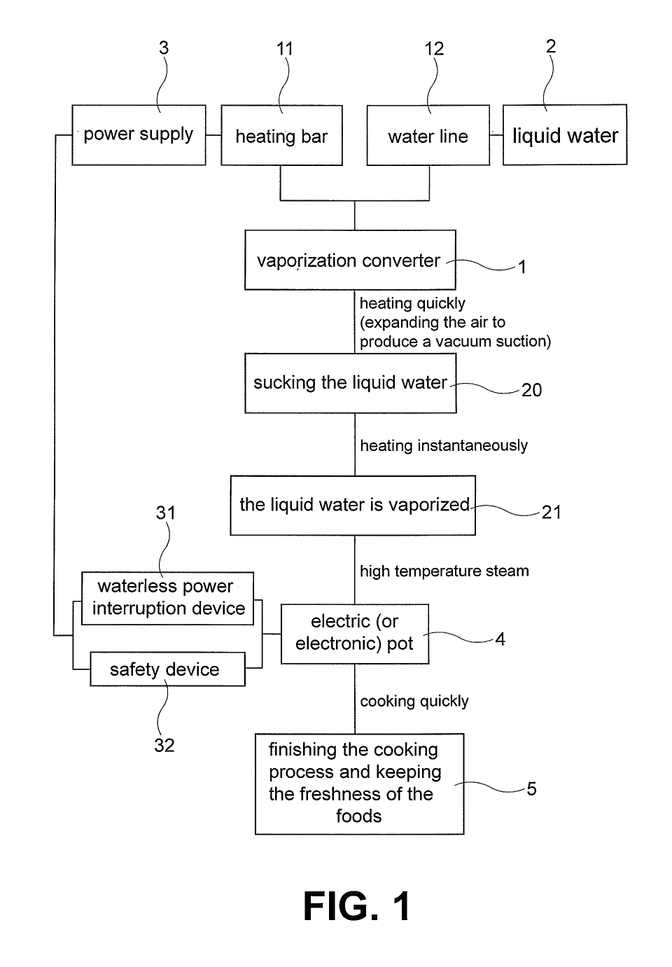

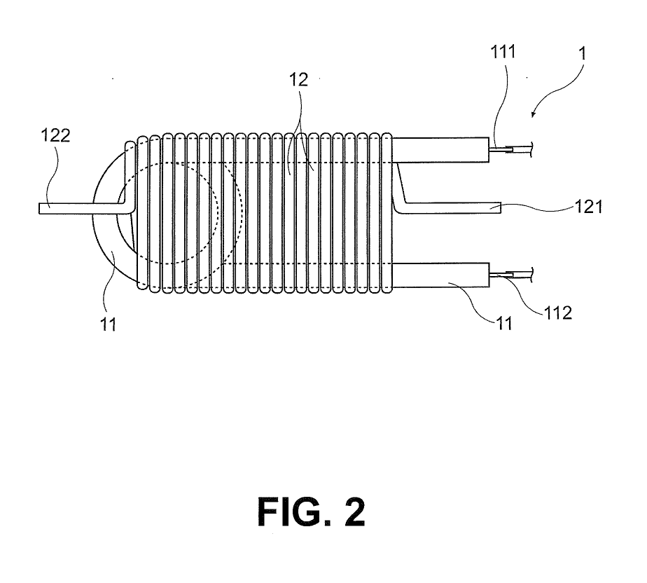

Referring to the drawings and initially to FIGS. 1 and 2, a household electro-thermal vaporization converter 1 in accordance with the preferred embodiment of the present invention comprises a heating bar 11 and a water line 12 wound around the heating bar 11. The converter 1 is mounted in an electric or electronic appliance, such as an electric (or electronic) pot 4. The electric (or electronic) pot 4 is provided with a waterless power interruption device 31 and a safety device 32. The heating bar 11 is connected with a power supply 3. The water line 12 is connected with a liquid water 2 to introduce and allow passage of the liquid water 2. Preferably, the water line 12 is a micro water line.

In practice, when the converter 1 is conducted by the power supply 3, the converter 1 is heated rapidly to heat and increase the temperature of the heating bar 11 so that the air in the water line 12 is expanded to produce a vacuum suction force. In such a manner, the liquid water 2 is sucked into the water line 12 by a siphon principle as indicated by the reference number 20, and is heated successively in the water line 12 so that the liquid water 2 in the water line 12 is nanometer vaporized (at the temperature of about 300 to 400° C.) as indicated by the reference number 21, and produces a high temperature steam. Then, the high temperature steam is sprayed into the electric (or electronic) pot 4 so as to cook items (such as food, soup and the like) contained in the electric (or electronic) pot 4. Thus, the high temperature steam quickly cooks the items in the electric (or electronic) pot 4 so as to finish the cooking process and to keep the freshness of the items as indicated by the reference number 5. The waterless power interruption device 31 is connected between the power supply 3 and the electric (or electronic) pot 4 to shut the electric power of the electric (or electronic) pot 4 when the water in the electric (or electronic) pot 4 is used up. In addition, the safety device 32 is connected between the power supply 3 and the electric (or electronic) pot 4 to shut the electric power of the electric (or electronic) pot 4 when the temperature in the electric (or electronic) pot 4 exceeds a preset value.

Referring to FIG. 2 with reference to FIG. 1, the heating bar 11 is made of a material with great heat conductivity, and the water line 12 is made of a material with great heat conductivity so that the heating bar 11 and the water line 12 can rapidly increase the temperature of the liquid water 2 and to convert the liquid water 2 into a high temperature nanometer vaporized state. The heating bar 11 is initially bent to have a determined shape, such as a U-shaped profile. Then, the water line 12 is wound around the heating bar 11 to absorb the heat energy of the heating bar 11 on a larger scale. Thus, the heating bar 11 and the water line 12 construct the converter 1. Then, the two terminals 111 and 112 of the heating bar 11 are conducted by the power supply 3, so that the heating bar 11 produces a heat energy with a high temperature. The water line 12 has a hollow tubular shape and has a water inlet 121 and a water outlet 122.

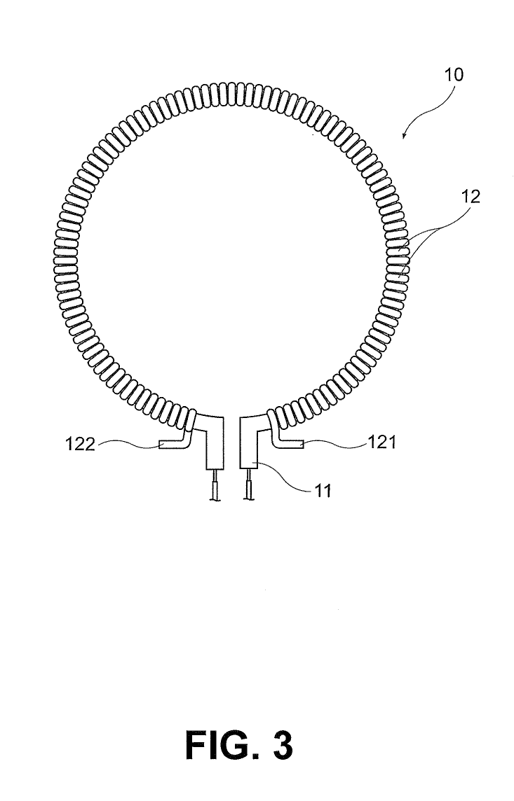

Referring to FIG. 3, the heating bar 11 is initially bent to have a circular shape. Then, the water line 12 is wound around the outer surface of the heating bar 11. Thus, the converter 10 has a circular shape.

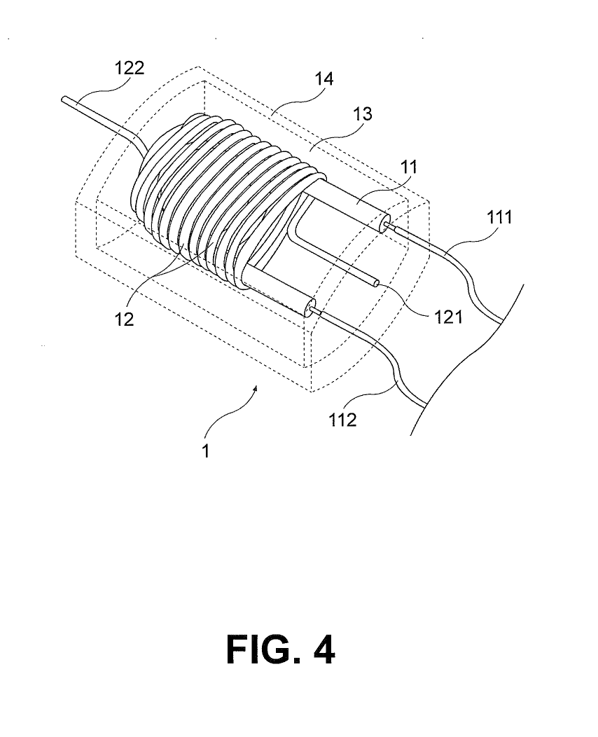

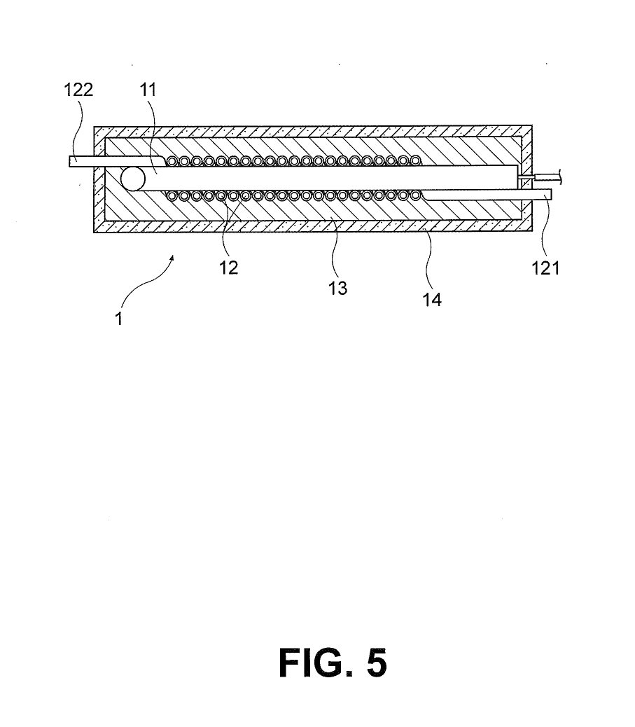

Referring to FIGS. 4 and 5, the converter 10 further comprises a covering layer 13 encompassing the heating bar 11 and the water line 12, and a heat insulating layer 14 mounted on an outer surface of the covering layer 13. Thus, the covering layer 13 enhance the heating effect of the heating bar 11 and the water line 12. In addition, the heating bar 11 and the water line 12 are fully isolated by the covering layer 13 and heat insulating layer 14 to prevent the peripheral elements of the electric (or electronic) pot 4 from being distorted or deformed due to the high temperature and to prevent the user from being burned or scaled by the high temperature.

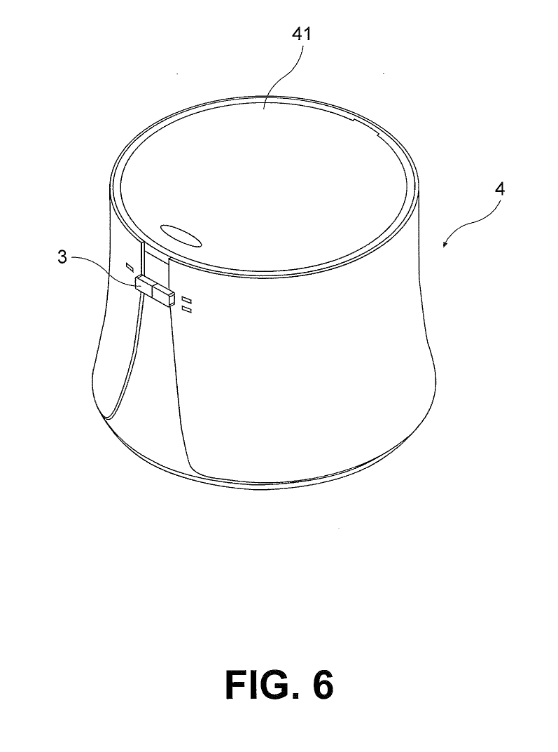

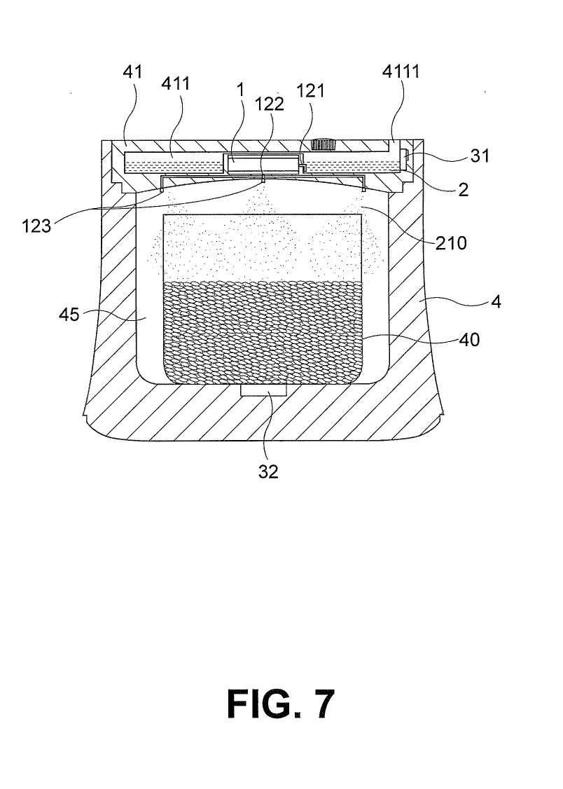

Referring to FIGS. 6 and 7 with reference to FIG. 1, the electric (or electronic) pot 4 has a top provided with a lid 41 and has an interior formed with a closed chamber 45 for mounting an inner pan 40. The lid 41 has an interior formed with a water tank 411 for storing the liquid water 2 and has a top formed with an opening 4111 connected to the water tank 411 to introduce the liquid water 2 into the water tank 411. The converter 1 is mounted in any position of the electric (or electronic) pot 4. In the preferred embodiment of the present invention, the converter 1 is mounted in the lid 41. The water inlet 121 of the water line 12 is connected with the water tank 411 of the lid 41. The water outlet 122 of the water line 12 is connected with a plurality of nozzles 123 each extended into and connected to the closed chamber 45 of the electric (or electronic) pot 4. The nozzles 123 are located above the closed chamber 45 of the electric (or electronic) pot 4.

When in use, after the converter 1 is conducted by the power supply 3, the converter 1 is heated rapidly to heat and increase the temperature of the heating bar 11 so that the air in the water line 12 is expanded to produce a vacuum suction force. In such a manner, the liquid water 2 in the water tank 411 is sucked into and heated successively in the water line 12 so that the liquid water 2 in the water line 12 is nanometer vaporized (at the temperature of about 300 to 400° C.), and produces a high temperature nanometer steam 210. Then, the high temperature nanometer steam 210 is sprayed through the water outlet 122 and the nozzles 123 into the closed chamber 45 of the electric (or electronic) pot 4 so as to cook the items (such as food, soup, stock and the like) contained in the inner pan 40 in a steam cooking manner. Thus, the high temperature nanometer steam 210 heats and cooks the items instantaneously so as to keep the freshness of the items in the electric (or electronic) pot 4 and to reduce the cooking time largely. The waterless power interruption device 31 is mounted on the lid 41 and is connected with the water tank 411 of to shut the electric power of the electric (or electronic) pot 4 when the liquid water 2 in the water tank 411 of the lid 41 is exhausted. In addition, the safety device 32 is mounted on any position of the electric (or electronic) pot 4 and is connected with the closed chamber 45 of the electric (or electronic) pot 4 to shut the electric power of the electric (or electronic) pot 4 when the temperature in the closed chamber 45 of the electric (or electronic) pot 4 exceeds a preset value. In addition, the converter 1 is a device with a high temperature and a low pressure so that the user can operate the converter 1 safely.

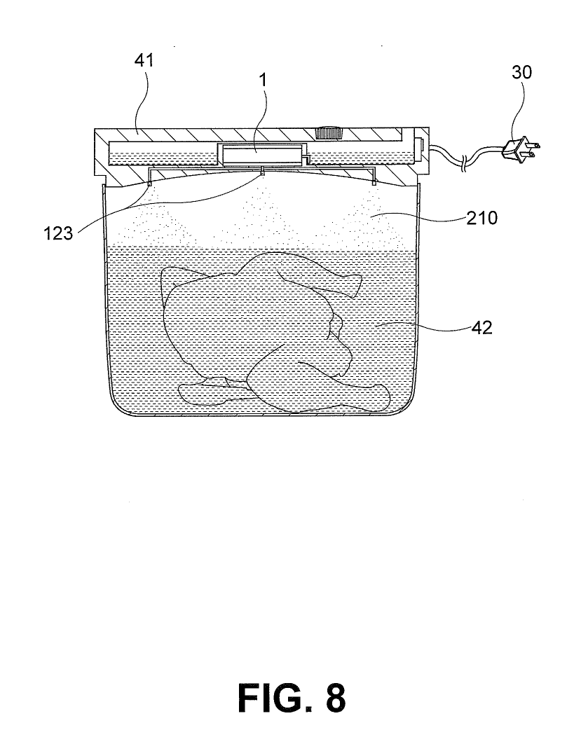

Referring to FIG. 8 with reference to FIG. 1, the lid 41 is mounted on a stock pot 42 to seal an open top of the stock pot 42, and the converter 1 is mounted in the lid 41. The lid 41 has a side provided with a power starting device 30, such as a plug and the like. Thus, the converter 1 is connected with the power supply 3 through the power starting device 30. After the converter 1 is conducted by the power supply 3, the high temperature nanometer steam 210 produced in the converter 1 is sprayed through the nozzles 123 into the stock pot 42 so as to cook the foods contained in the stock pot 42 in a steam cooking manner. Thus, the high temperature nanometer steam 210 directly penetrates through the foods so as to cook the foods quickly and to keep the foods fresh in the stock pot 42, thereby preventing the soup or stock from being mixed or muddled in the stock pot 42.

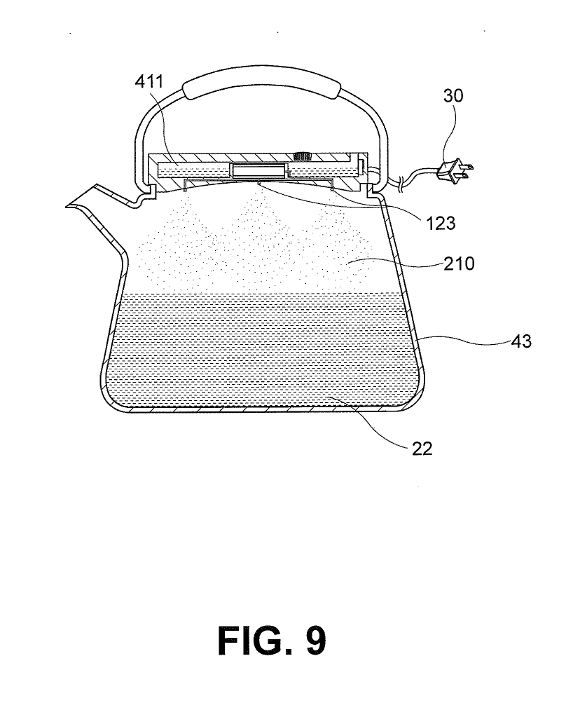

Referring to FIG. 9 with reference to FIG. 1, the lid 41 is mounted on a kettle 43 to seal an open top of the kettle 43, and the converter 1 is mounted in the lid 41. The lid 41 has a side provided with a power starting device 30, such as a plug and the like. Thus, the converter 1 is connected with the power supply 3 through the power starting device 30. After the converter 1 is conducted by the power supply 3, the high temperature nanometer steam 210 produced in the converter 1 is sprayed through the nozzles 123 into the kettle 43 so as to heat and boil the liquid 22 contained in the kettle 43 in a steam cooking manner.

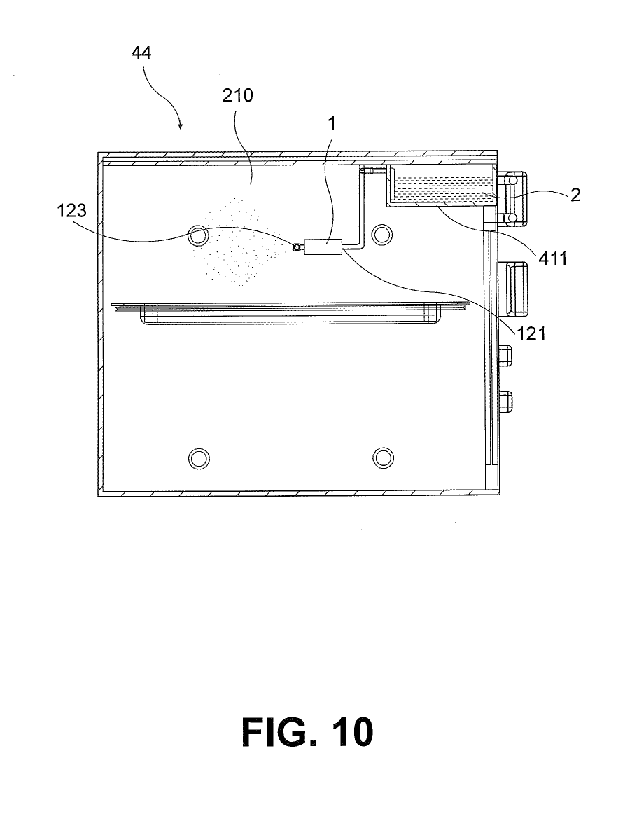

Referring to FIG. 10 with reference to FIG. 1, the converter 1 is mounted in an oven 44. The oven 44 has a side provided with a water tank 411 for storing the liquid water 2. The water inlet 121 of the water line 12 is connected with the water tank 411. The water outlet 122 of the water line 12 is connected with a plurality of nozzles 123. After the converter 1 is conducted by the power supply 3, the high temperature nanometer steam 210 produced in the converter 1 is sprayed through the nozzles 123 into the oven 44 so as to keep the moisture of the foods baked in the oven 44, thereby preventing the foods from being burned during the baking process.

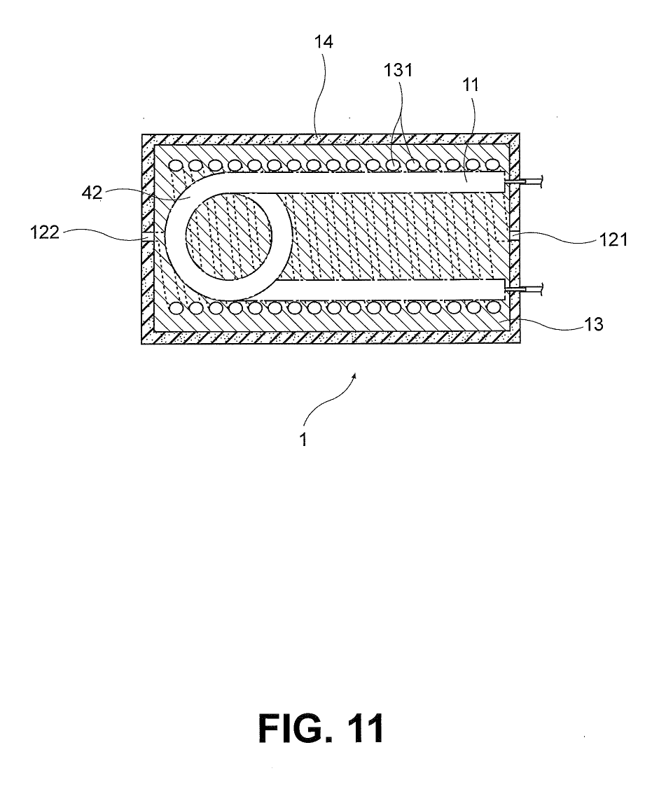

Referring to FIG. 11 with reference to FIGS. 1 and 7, a converter 1 in accordance with another preferred embodiment of the present invention comprises a heating bar 11, a covering layer 13 encompassing the heating bar 11, and a heat insulating layer 14 mounted on an outer surface of the covering layer 13. The covering layer 13 has an interior formed with a helical channel 131 wound around an outer surface of the heating bar 11. The helical channel 131 has a water inlet 121 and a water outlet 122. The water inlet 121 is connected with the water tank 411. The liquid water 2 is stored in the water tank 411. Thus, the helical channel 131 is connected with the liquid water 2 to introduce and allow passage of the liquid water 2.

In practice, when the converter 1 is conducted by the power supply 3, the converter 1 is heated rapidly to heat and increase the temperature of the heating bar 11 so that the air in the helical channel 131 is expanded to produce a vacuum suction force. In such a manner, the liquid water 2 in the water tank 411 is sucked into the helical channel 131 by a siphon effect, and is heated successively in the helical channel 131 so that the liquid water 2 in the helical channel 131 is nanometer vaporized, and produces a high temperature steam. Then, the high temperature steam is sprayed outward through the water outlet 122. to cook foods contained in the electric (or electronic) pot 4.

Accordingly, the liquid water 2 is vaporized instantaneously by operation of the converter 1 to produce a high temperature steam which is used to cook the foods quickly and completely, so as to keep the freshness of the foods, and to shorten the cooking time. In addition, the converter 1 is available for various electric (or electronic) appliances, such as pots, pans, ovens, kettles and the like, thereby enhancing the versatility of the converter 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A converter, comprising:
a heating bar;
a water line; and
a covering layer; wherein:
the heating bar is connected with a power supply;
the water line is hollow;
either the water line or the covering layer is mounted on the heating bar;
the water line is selectively wound around the heating bar;
the covering layer has an interior formed with a helical channel selectively wound around the heating bar;
each of the water line and the helical channel of the covering layer has a first end connected with a water tank and a second end connected with at least one nozzle;
when the heating bar is conducted and heated by the power supply, either the water line or the helical channel of the covering layer is heated to increase its temperature successively, with air in either the water line or the helical channel of the covering layer being expanded to suck a liquid in the water tank into either the water line or the helical channel of the covering layer by a siphon principle, and with the liquid being heated successively in either the water line or the helical channel of the covering layer to produce a high temperature nanometer steam; and
the high temperature nanometer steam is sprayed outward through the nozzle.

2. The converter of claim 1, wherein the heating bar is bent to have any shape.

3. The converter of claim 1, wherein the converter includes more than one nozzle.

4. The converter of claim 1, further comprising a heat insulating layer mounted on an outer surface of the heating bar, the water line or the covering layer.

5. A converter, comprising a heating bar and a water line or a covering layer, wherein the converter is placed in any position of a closed chamber or a lid.

6. The converter of claim 5, wherein the closed chamber is a pot, kettle or oven.

7. The converter of claim 6, wherein the closed chamber is provided with a waterless power interruption device and a safety device each connected with a power supply of the heating bar.
